(19) United States
(12) Patent Application Publication
(10) Pub. No.: US 2026/0217876 A1
(43) Pub. Date: Jul. 30, 2026

(54) PROCESS FOR THE PREPARATION OF A CATALYST SYSTEM

(71) Applicant: SABIC GLOBAL TECHNOLOGIES B.V., Bergen op Zoom (NL)

(72) Inventors: Coen HENDRIKSEN, Eindhoven (NL); Robert Lap Key CHAN, Best (NL); Vikas Shripat KSHIRSAGAR, Maastricht (NL); Jens PANITZKY, Dorsten (DE)

(21) Appl. No.: 19/141,456

(22) PCT Filed: Dec. 14, 2023
(86) PCT No.: PCT/EP2023/085919

§ 371 Date: Jun. 20, 2025

(30) Foreign Application Priority Data
Dec. 23, 2022 (EP) 22216460.0

(51) Int. Cl. C08F 10/02

(52) U.S. Cl. CPC C08F 10/02

(57) ABSTRACT

Process for the production of a catalyst system including 1) providing a solution I—wherein solution I includes a hydrocarbon solution including the reaction product of a) a magnesium-containing compound selected from an organic oxygen-containing magnesium compound and/or a halogen-containing magnesium compound; and b) an organic oxygen-containing titanium compound wherein the molar ratio of magnesium: titanium is lower than 3:1; 2) providing a solution II—wherein solution II includes a hydrocarbon solution including—an organo aluminium halide having the formula AlRₙX₃₋ₙ in which R is a hydrocarbon moiety containing 1-10 carbon atoms, X is a halogen and 0<n<3; 3) selecting a value Y the range from 1-12, wherein Y is defined as the molar ratio of aluminium of solution II to titanium of solution I, 4) dosing solution I and II to a receiving means in a time t from ≥t₁ to <t_{end}.

### CROSS REFERENCE TO RELATED APPLICATIONS

This application is a National Stage application of PCT/EP2023/085919, filed Dec. 14, 2023, which claims the benefit of European Application No. 22216460.0, filed Dec. 23, 2022, both of which are incorporated by reference in their entirety herein.

### BACKGROUND

The present invention relates to a process for the preparation of a catalyst system for the production of polyethylene and a process for the production of polyethylene.

Polyethylene can be produced in a gas phase, a solution or a slurry process. In the ethylene slurry polymerization process, diluents such as hexane or isobutane are used to dissolve the ethylene monomer, comonomers and hydrogen to polymerize the monomer(s) in the presence of a catalyst system. Following polymerization, the polyethylene product formed is present as slurry of solid polyethylene particles suspended in the liquid medium, as the polyethylene polymer particles are insoluble or substantially insoluble in the diluent.

In the polyethylene polymerization process a good polymer particle morphology is required for smooth operation of the plant. Polymer powder morphology encompasses uniformity of polymer particle size and shape, good flowability and high bulk density.

The bulk density of the polymer powder refers to the mass of the powder per unit of volume. This is an important parameter because the obtained powder has to be stored and to be transported. A higher bulk density may for example decrease clogging at its transportation and it is possible to increase the storable amount per unit volume. By increasing the bulk density, the weight of the polyethylene per unit volume present in a polymerization vessel will be increased and the concentration of the polyethylene powder in the polymerization vessel can be enhanced.

Moreover the formation of small polymer particles (polymer particles <100 μm), also called fines, which could be caused by fragmentation of the polymer particles need to be overcome. In particular dryer and decanter performance suffer from sheeting and fouling caused by small polymer particles. This fouling leads for example to a decrease in the efficiency of heat exchangers. In addition, the equipment needs to be cleaned more often, which is expensive and leads to production losses. Likewise, the particles may deposit on sensors causing issues in controlling the polymerization process or deposition may lead to plugging of pipelines. Meanwhile it is now widely accepted that the morphology of polymer particles is mainly determined by the morphology of the catalyst particles through the replication phenomenon. Thus there is a need to improve catalyst particle morphology. At the same time it is desired that the catalyst system shows a high activity. On top of that it is required that the catalyst system can be synthesized in an easy and simple way on commercial scale.

It is therefore object of the invention to provide a process for the preparation of a catalyst system which shows a high catalyst activity, is easy to prepare and results in polyethylene powder particles displaying a high powder bulk density, uniformity of particle size, good flowability and high bulk density.

### SUMMARY

Surprisingly it has been found, that this object has been achieved at least in part by the process for the production of a catalyst system according to the invention which comprises the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising an organo aluminium halide having the formula AlRₙX₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time where no further solution selected from solution I or II or I and II is dosed.

### BRIEF DESCRIPTION OF THE FIGURES

FIG. 1 shows laser diffraction PSD curves of homopolymerization of PE powder from Ex.1-4;

FIG. 2 shows an image analysis of Ex. 2 and Ex. 4 Comparative;

FIG. 3 shows a representative SEM image of PE powder from Ex. 2;

FIG. 4 shows a representative SEM image of PE powder from Ex. 4 Comp;

FIG. 5. laser diffraction PSD curve of Ex. 7, Inv. Cat. 2;

FIG. 6 shows a SEM image of Ex.7 Cat 2 of the PE copolymer;

FIG. 7 shows a SEM image of Ex. 8 Cat Comp. 1 of the PE copolymer;

FIG. 8 shows light scattering image analysis PSD curves of Ex. 7 and Ex. 8 Comp. of the PE polymer; and

FIG. 9 shows a typical dosing profile of dosing solution I and solution II, preferably simultaneously, to a receiving means.

### DETAILED DESCRIPTION

Preferably, the receiving means is a reactor vessel. Preferably the reactor vessel if a glass reactor. The average Average Particle Size Distribution (PSD) may be defined as PSD=(D90-D10)/D50 wherein D90 is the percentile value that indicate the size below which 90% of all particles are found, D10 is the percentile value that indicate the size below which 10% of all particles are found, D50 is the percentile value that indicate the size below which 50% of all particles are found, and wherein the particle size is determined using laser diffraction.

Dosing of solution I and II simultaneously to a receiving means, for example a reactor vessel, signifies that both solution I and solution II are added to the reactor vessel together as opposed to sequentially.

The catalyst system obtained by the process according to the invention leads to polymer powder particles showing a good flowability. This ensures that the powder can be dosed easily for example to the extruder for pelletization. Furthermore, the polymer powder particles show less fines and a narrow particle size distribution. Next to that, the catalyst system obtained by the process according to the invention shows a high productivity. This means that the catalyst residues in the polymer are very low.

The process according to the invention is relatively simple and cheap and based on readily available and relatively easy to handle compounds.

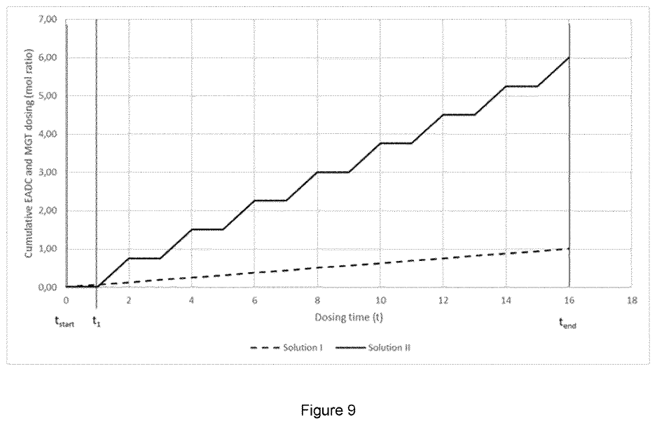

FIG. 9 shows a typical dosing profile of dosing solution I and solution II, preferably simultaneously, to a receiving means.

Solution I may for example be dosed continuously as shown in FIG. 9 or stepwise at any time t from ≥t₁ to <t_{end} or at any time from ≥tₛₜₐᵣₜ to <t₁. Solution II may for example be dosed stepwise as shown in FIG. 9 or continuously at any time t from ≥t₁ to <t_{end}.

At t_{end} the selected a value Y, which may be in the range from 1-12, and which is defined as the molar ratio of aluminium of solution II to titanium of solution I is obtained. In FIG. 9 this is a ratio of Y=6.

It is required that at any time t from ≥t₁ to <t_{end} the selected Y is kept in a range of range of Y−35% to Y+5% of Y. For the example in FIG. 9 this means the ratio should be in a range from 6-35% to 6+5%, thus Y should be in the range of 3,9-6,3.

Solution I, solution II or solution I and II may be dosed at any time t from ≥t₁ to <t_{end}. In FIG. 9 either solution I and II are dosed or only solution I is dosed.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising an organo aluminium halide having the formula AlRₙX₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4b) dosing solution I to a receiving means in the time from ≥tₛₜₐᵣₜ to <t₁, wherein tₛₜₐᵣₜ is a point in time before t₁ and wherein the time between from ≥tₛₜₐᵣₜ to <t₁ may be in the range of 0.05 to 0,125 of the total dosing time ≥tₛₜₐᵣₜ to ≤t_{end},
4c) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

The total dosing time of the process ≥tₛₜₐᵣₜ to ≤t_{end} may be in the range of 5 to 120 minutes, preferably 5-30 minutes, most preferably 5-20 minutes. As seen in FIG. 9 this may be 16 minutes.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising
   an organo aluminium halide having the formula AlRₙX₃₋ₙ in which R is a hydrocarbon moiety containing 1-10 carbon atoms, X is a halogen and 0<n<3;
3) selecting a value Y the range from 4-12, preferably 5-10, more preferably 5-9, most preferably 6-9 wherein Y is defined as the molar ratio of aluminium of solution II to titanium of solution I,
4) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁, to <t_{end},
wherein at t_{end} the selected range of Y is obtained and t_{end} is defined as a point in time where no further solution selected from solution I or II or I and II is dosed.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising
   an organo aluminium halide having the formula AlRₙX₃₋ₙ in which R is a hydrocarbon moiety containing 1-10 carbon atoms, X is a halogen and 0<n<3;
3) selecting a value Y in the range from 4-12, preferably 5-10, more preferably 5-9, most preferably 6-9, wherein Y is defined as the molar ratio of aluminium of solution II to titanium of solution I,
4b) dosing solution I to a receiving means in the time from ≥tₛₜₐᵣₜ to <t₁, wherein tₛₜₐᵣₜ is a point in time before t₁ and wherein the time between from ≥tₛₜₐᵣₜ to <t₁ may be in the range of 0.05 to 0,125 of the total dosing time ≥tₛₜₐᵣₜ to ≤t_{end},
4c) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

The process for the production of a catalyst system may for example comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound
      wherein the molar ratio of magnesium: titanium is lower than 3:1;
2) providing a solution II
   wherein solution II comprises a hydrocarbon solution comprising
   an organo aluminium halide having the formula AIR X₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4) dosing solution I and II, preferably simultaneously, to a receiving means in a time t from ≥t₁ to <t_{end} in such a way that Y might vary in the range of Y−30% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

In the catalyst preparation process, Y may be kept constant at the selected value Y, preferably between 1-12, 4 to 12, preferably 5-10, more preferably 5-9, most preferably 6-9, at any point in time t in the time t of ≥t₁ to <t_{end}.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising
   an organo aluminium halide having the formula AIR X₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4a) dosing a hydrocarbon solution, preferably hexane, to the receiving means prior to dosing any solution selected form solution I or II or I and II,
4c) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time where no further solution selected from solution I or II or I and II is dosed.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising
   an organo aluminium halide having the formula AlRₙX₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4a) dosing a hydrocarbon solution, preferably hexane, to the receiving means prior to dosing any solution selected form solution I or II or I and II,
4b) dosing solution I to a receiving means in the time from ≥tₛₜₐᵣₜ to <t₁, wherein tₛₜₐᵣₜ is a point in time before t₁ and wherein the time from ≥tₛₜₐᵣₜ to <t₁ may be in the range of 0.05 to 0,125 of the total dosing time ≥tₛₜₐᵣₜ to ≤t_{end},
4c) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is lower than 3:1;
2) providing a solution II
   wherein solution II comprises a hydrocarbon solution comprising an organo aluminium halide having the formula AIR X₃₋ₙ in which R is a hydrocarbon moiety containing 1-10 carbon atoms, X is a halogen and 0<n<3;
3) selecting a value Y in the range from 4-12, preferably 5-10, more preferably 5-9, most preferably 6-9, wherein Y is defined as the molar ratio of aluminium of solution II to titanium of solution I,
4a) dosing a hydrocarbon solution, preferably hexane, to the receiving means prior to dosing any solution selected form solution I or II or I and II,
4b) dosing solution I to a receiving means in the time from ≥tₛₜₐᵣₜ to <t₁, wherein tₛₜₐᵣₜ is a point in time before t₁ and wherein the time from ≥tₛₜₐᵣₜ to <t₁ may be in the range of 0.05 to 0,125 of the total dosing time ≥tₛₜₐᵣₜ to ≤t_{end},
4c) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

After the dosing step 4) of solution I and/or II, the unreacted reagent like soluble Ti- and AI-species may be removed from the catalyst slurry. Soluble contaminants may be removed by filtration or decantation of the catalyst slurry. For decantation of the catalyst, it is desired that the catalyst shows a good sedimentation behavior. A slow sedimentation behavior would increase the time to perform a decantation step, thus increasing the time to prepare a catalyst batch. Thus it is evident that it is desirable to reduce the sedimentation time during catalyst production. The catalyst system according to the invention shows a sedimentation behavior that is much improved compared to conventional precipitation methods.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound and/or a halogen-containing magnesium compound; and
      b) an organic oxygen-containing titanium compound wherein the molar ratio of magnesium: titanium is in the range of 1,5:1 to 2,2:1;
2) providing a solution II
   wherein solution II comprises a hydrocarbon solution comprising an organo aluminium halide having the formula AlRₙX₃₋ₙ in which R is a hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

The organic oxygen-containing magnesium compound may for example be selected from magnesium alkoxides such as magnesium methylate, magnesium ethylate and magnesium isopropylate, magnesium alkylalkoxides such as magnesium ethylethylate, and carbonized magnesium alkoxides such as magnesium ethyl carbonate. For example, the organic oxygen-containing magnesium compound may be a magnesium alkoxide. For example, the magnesium alkoxide may be magnesium ethoxide (Mg(OC₂H₅)₂).

The halogen-containing magnesium compound may for example be selected from magnesium dihalides and magnesium dihalide complexes. For example, the halide in said magnesium dihalides and magnesium dihalide complexes may be chlorine.

Preferably, the oxygen-containing titanium compound is selected from titanium alkoxides. The titanium alkoxide may for example be selected from Ti (OC₂H₅) 4, Ti (OC₃H₇)₄, Ti(OC₄H₉)₄ and Ti(OC₈H₁₇)₄. Preferably, the titanium alkoxide is Ti (On-C₄H₉)₄.

The organo aluminium halide I) b) may for example be a compound having the formula an AlRₙX₃₋ₙ wherein R is a hydrocarbon moiety containing 1-10 carbon atoms, X is a halogen and 0<n<3; preferably 1.5<n<3.

The organo aluminium halide I) b) may for example be selected from ethyl aluminium dibromide, ethyl aluminium dichloride, propyl aluminium dichloride, n-butyl aluminium dichloride, isobutyl aluminium dichloride, diethyl aluminium chloride and diisobutyl aluminium chloride. Preferably, X is chlorine. Preferably, the organo aluminium halide I) b) is an organo aluminium chloride. Most preferably, the organo aluminium halide I) b) is ethyl aluminium dichloride.

The aluminium compound having the formula AIR3 may for example be selected from triethyl aluminium, triisobutyl aluminium, tri-n-hexyl aluminium and trioctyl aluminium. For example, the aluminium compound having the formula AIR′3 may be triethyl aluminium or triisobutyl aluminium. The aluminium compound having the formula AIR3 functions for example as a cocatalyst.

The process for the production of a catalyst system may comprise the steps of
1) providing a solution I
   wherein solution I comprises a hydrocarbon solution comprising the reaction product of
      a) a magnesium-containing compound selected from an organic oxygen-containing magnesium compound, preferably Mg(OC₂H₅)₂; and
      b) an organic oxygen-containing titanium compound being a titanium alkoxide, preferably Ti (On-C₄H₉)₄,
      wherein the molar ratio of magnesium: titanium is lower than 3:1;
2) providing a solution II
   wherein solution II comprises a hydrocarbon solution comprising an organo aluminium halide having the formula AIRX₃₋ₙ in which R is a hydrocarbon moiety containing 1-10 carbon atoms, preferably R is ethyl and X is chloride and 0<n<3, preferably n is 1;
3) selecting a value Y the range from 1-12, wherein Y is defined as the molar ratio of aluminium of solution II to titanium of solution I,
4) dosing solution I and II, preferably simultaneously, to a receiving means in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

Polyethylenes, in particular high density polyethylenes (HDPE) constitute a class of materials which have a balance of material properties that are particularly desirable for a range of applications, in particular for pipes and tubes produced via extrusion moulding processes. For example, high density polyethylenes may have a unimodal molecular weight distribution or a multimodal molecular weight distribution. Such unimodal molecular weight distribution or multimodal molecular weight distribution results in a particular balance of material properties. Said multimodal molecular weight distribution may be achieved by employing for example two or more polymerisation reactors in cascade in the process for production of multimodal HDPE, further referred to as multi-stage polymerisation processes. Such multi-stage polymerisation processes are described in for example “PE 100 Pipe Systems”, Bromstrup (ed), Vulkan Verlag, 2004, p. 16-20.

The process for the production of polyethylene according to the invention comprises the step of producing the catalyst system according to the invention and polymerizing ethylene by contacting said catalyst system with ethylene.

The polymerisation process for production of polyethylenes may for example comprise a single polymerisation stage. Alternatively the process for production of polyethylenes may for example comprise multiple polymerisation stages, in which the process comprises at least one slurry polymerisation process. Said process for the production of polyethylenes comprising multiple polymerisation stages is also referred to as a multi-stage polymerisation process.

The process for production of polyethylenes is preferably a multi-stage polymerisation process comprising at least two stages.

Each individual stage of said multi-stage polymerisation process may comprise a separate polymerisation reactor, which are set up in cascade so as together to form said multi-stage polymerisation process. The operating conditions of each polymerisation reactor may different or may be the same as in the other polymerisation reactors in cascade together forming said multi-stage polymerisation process.

The process for production of polyethylenes may for example be a slurry polymerisation process at low temperature and low pressure. The slurry that is used in the slurry polymerisation process is defined as a liquid system comprising a diluent as liquid phase, feed monomers, the catalyst system and the polymer particles formed in the course of the polymerisation. As diluent, a hydrocarbon is used that is not reactive under the conditions occurring in the polymerisation process, and which is in a liquid phase under the conditions occurring in the polymerisation process. The diluent may for example be hexane. Low pressure polymerisation is defined as polymerisation at partial pressures of ethylene in the range between for example 0.3 MPa and 5.0 MPa, alternatively between for example 0.5 MPa and 3.0 MPa, alternatively between for example 0.5 and 2.0 MPa. Low temperature polymerisation is defined as polymerisation at temperatures in the range between for example 70° C. and 90° C.

The process for the production of polyethylene may comprise at least one stage comprising a slurry process.

The process for the production of polyethylene may be a multistage polymerisation process wherein the catalyst system is introduced in the first stage of said multi-stage polymerisation process.

The catalyst system according to the invention is sufficiently sensitive to hydrogen, to be used in a multi-stage polymerisation process for the production of multimodal HDPE. Furthermore, the catalyst system according to the invention is able to produce a low molecular weight polymer fraction according to the desired characteristics of molecular weight distribution, and also to produce a high molecular weight copolymer fraction.

The process for the production of polyethylene using the catalyst system according to the invention may result in polyethylene having a density of ≥935 kg/m³ and ≤975 kg/m₃ as measured in accordance with ISO 1183-1 (2012), method A.

Preferably, the process for the production of polyethylene using the catalyst system according to the invention is a multistage process resulting in polyethylene that is a multimodal polyethylene.

The weight fraction of the polyethylene produced in the first stage of said multi-stage slurry polymerisation process compared to the total weight of the polymer produced may be for example greater than 20.0 wt %, alternatively greater than 30.0 wt %, alternatively greater than 40.0 wt %. The weight fraction of the polyethylene produced in the first stage of said multi-stage slurry polymerisation process compared to the total weight of the polymer produced may be for example less than 80.0 wt %, alternatively less than 70.0 wt %, alternatively less than 60 wt.

The weight fraction of the polyethylene produced in the first stage of said multi-stage slurry polymerisation process compared to the total weight of the polymer produced may be for example between 40.0 wt % and 60.0 wt % of the total product, alternatively between 47 wt % and 58 wt %. The polymerisation may for example be carried out in the presence of one or more anti-fouling agents. For example, up to 500 ppm of weight of anti-fouling agents may be used, related to the total amount of reactor contents.

The polymerisation may be carried out in the presence of one or more anti-static agents. For example, up to 500 ppm of said one or more anti-static agents used, related to the total amount of reactor contents.

The polyethylenes according to the present invention may be unimodal or multimodal polyethylenes. Unimodal polyethylenes in the context of the present invention are defined as polyethylenes having a unimodal molecular weight distribution. Multimodal polyethylenes in the context of the present invention are defined as polyethylenes having a multimodal molecular weight distribution. The molecular weight distribution is defined as the relation between the molecular weight of a polymer molecule present in a polymer sample and the number of molecules in said polymer sample having said molecular weight. Said multimodal molecular weight distribution reflects the combination of the molecular weight distributions of the polyethylenes prepared in each stage of said multi-stage polymerisation process.

The molecular weight distribution of polyethylenes according to the present invention may be determined via Size Exclusion Chromatography such as presented in “Handbook of” Polyethylene, structure, properties and applications “, A. Peacock, Dekker, New York, 2000, pages 242-244. Production of” polyethylenes in slurry polymerisation processes in general takes place in the presence of a catalyst system. Such catalyst systems may for example comprise a catalyst, a cocatalyst and an electron donor.

In the context of the present invention, polyethylenes are to be understood to be the polymer products obtained as output of the polymerisation process.

Polyethylenes are described in ‘Olefin Polymers, Introduction’, Y. Kissin, in: Kirk-Othmer Encyclopedia of Chemical Technology, Wiley, 2005 (DOI: 10.1002/0471238961.0914201811091919.a01.pub2).

In polyethylene production processes, the process and the catalyst have to form a well-balanced system in order to arrive at products of the desired characteristics whilst allowing for an efficiently operating process.

The catalyst system obtained or obtainable by the process according to the invention wherein the average particle size distribution (PSD) of the catalyst particles is in the range of 0,8 to 1,6 and wherein PSD is defined as PSD=D90-D10)/D50 and D10, D90 and D50 are measured by laser diffraction.

Use of the catalyst system according to the invention for the production of polyethylene.

The polyethylene obtained or obtainable by the catalyst system according to the invention or by the process according to the invention comprises polyethylene powder particles having a particle size distribution in the range of 0,70-1,40.

The polyethylene obtained or obtainable by the catalyst system according to the invention or by the process according to the invention comprises polyethylene powder particles having a dry flow in the range from 15-36 s.

The polyethylene obtained or obtainable by the catalyst system according to the invention or by the process according to the invention comprises polyethylene powder particles having a particle size distribution in the range of 0,70-1,40 and a dry flow in the range from 15-36 s.

The polyethylenes according to the present invention may for example be high density polyethylenes, further referred to as HDPE. The polyethylenes may for example be polyethylene's having a density as measured in accordance with ISO 1183-1 (2012), method A of ≥935 kg/m³, alternatively for example ≥940 kg/m³. The polyethylenes may for example be polyethylenes having a density of ≤975 kg/m³, alternatively for example≤970 kg/m³, alternatively for example ≤965 kg/m³. The polyethylenes may for example be polyethylenes having a density in the range of ≥935 kg/m³ and ≤975 kg/m³, alternatively for example in the range of ≥940 kg/m³ and ≤970 kg/m³, alternatively for example in the range of ≥940 kg/m³ and ≤965 kg/m³.

The polyethylenes according to the present invention may for example be multimodal HDPE. Multimodal HDPE may for example be used for processing into objects via blow moulding, extrusion moulding or injection moulding. Multimodal HDPE may for example be used to produce films, pipes, tubes, and pipe fittings. Examples of multimodal HDPE pipes are pipes for drinking water, sewage, irrigation, natural gas transportation and cable conduits.

Multimodal HDPE is particularly suitable for processing into pipes and tubes by extrusion moulding. Extrusion moulding in the context of the present invention is defined as a process for shaping of thermoplastic materials, such as polyethylenes, including the steps of providing the thermoplastic material in a mouldable state to a die opening, extruding the thermoplastic material through said die opening and cooling the extruded material to below its softening temperature. Thermoplastic materials in the context of the present invention are defined as materials that obtain a mouldable state when heated to above a softening temperature, and that return to a solid state upon cooling to below said softening temperature.

Mouldable state in the context of the present invention is defined as a state in which a material can be formed into the desired shape whilst retaining said desired shape upon leaving the mould used to form said desired shape. In extrusion moulding, said die opening functions as said mould. An important material parameter of polyethylenes is the melt mass flow rate as determined in accordance with ISO 1133-1 (2011), at a temperature of 190° C. and a load of 5.0 kg, further referred to as MFR (5).

The MFR (5) of the multimodal polyethylenes may for example be≤100 g/10 min, alternatively≤50.0 g/10 min, alternatively≤25.0 g/10 min, alternatively≤10.0 g/10 min, alternatively≤5.00 g/10 min, alternatively≤4.00 g/10 min, alternatively≤3.00 g/10 min, alternatively≤2.00 g/10 min, alternatively≤1.00 g/10 min.

The MFR (5) of the multimodal polyethylenes may for example be ≥0.01 g/10 min, alternatively ≥0.05 g/10 min, alternatively >0.10 g/10 min, alternatively ≥0.15 g/10 min. For example, the MFR (5) of the multimodal polyethylenes according to the present invention may for example be ≥0.05 g/10 min and ≤10.0 g/10 min, alternatively for example ≥0.10 g/10 min and ≤5.00 g/10 min, alternatively for example ≥0.15 g/10 min and ≤2.00 g/10 min.

Another important material parameter of polyethylenes is the melt mass flow rate as determined in accordance with ISO 1133-1 (2011), at a temperature of 190° C. and a load of 21.6 kg, further referred to as MFR (21.6).

The MFR (21.6) of the multimodal polyethylenes according to the present invention may for example be≤500 g/10 min, alternatively≤200 g/10 min, alternatively≤100 g/10 min, alternatively ≤50.0 g/10 min, alternatively≤20.0 g/10 min.

The MFR (21.6) of the multimodal polyethylenes according to the present invention may for example be ≥0.50 g/10 min, alternatively ≥1.00 g/10 min, alternatively ≥2.00 g/10 min, alternatively ≥5.00 g/10 min, alternatively ≥10.0 g/10 min. For example, the MFR (21.6) of the multimodal polyethylenes according to the present invention may for example be ≥0.50 g/10 min and ≤200 g/10 min, alternatively for example ≥1.00 g/10 min and ≤100 g/10 min, alternatively for example ≥1.00 g/10 min and ≤50.0 g/10 min.

The invention will now be illustrated by the following non-limiting examples.

### EXAMPLES

### Measurement Methods

The melt-index MFR 21.6 or melt flow index (MFI) was measured according to method ISO1133 under a load of 21.6 kg at 190° C.
The density of the polymers is measured according to ISO1183
Bulk density measurements are performed according to DIN ISO 60:2000-01
Pourability of plastic materials are performed according to ASTM D1895-96
The catalyst particle size is measured using laser diffraction. This was done by using a
Mastersizer 3000 instrument equipped with a modified Hydro MV unit for automated wet dispersion of samples under an inert atmosphere. The catalyst particle size is calculated with the Mie theory using absorption coefficient=1, refractive index of the catalyst is 1.596 and the refractive index of the dispersant=1.39.
The polymer particle size is measured using laser diffraction. This was done by using a Mastersizer 3000 instrument equipped with an Aero S unit for dry powder dispersion of samples.

The catalyst particle size is calculated with the Fraunhofer theory.
The Particle Size Distribution (PSD) is calculated according to the following formula
PSD=(D90-D10)/D50 with D90 the percentile value that indicate the size below which 90% of all particles are found. D10 is the percentile value that indicate the size below which 10% of all particles are found. D50 is the percentile value that indicate the size below which 50% of all particles are found. D50 is also called the median particle diameter or median particle size. These values can be directly determined from the cumulative particle size distribution
Image analysis is performed on a Malvern Morphology G3SE with a Nikon CFI Brightfield/Darkfield inspection microscope (Eclips L200ND) and a Baumer 5 M pixels CCD digital color camera. A aliquot of the polyethylene powder of 19-38 mm³ was dry dispersed in air with aid of the Solid Dispersion Unit (SDU) on an object of glass with the following settings: an air pulse of 1 bar during 20 miliseconds and a settling time of 600 seconds. A magnification of 5x is used. To achieve an accurate focus across the entire body of small and large three-dimensional particles, up to 5 images at different focal points are taken of a particle and then merged to provide a single composed image.

### Catalyst Preparation

A) Preparation of precursor (A), (Preparation of Solution I)

Under a nitrogen atmosphere, 132.5 g of granular Mg(OC₂H₅)₂ and 199 ml of Ti (On-C₄H₉)₄, both at a temperature of 25° C. were introduced into a 2 L round bottom flask equipped with a reflux condenser and a stirrer. Under gentle stirring, the mixture was heated to 180° C. and subsequently stirred for 90 min. A clear liquid was obtained. The contents of the round bottom flask were cooled to 120° C., and subsequently diluted with 1318 g hexane. The contents of the round bottom flask were cooled to 67° C. The temperature was maintained at 67° C. for 120 min, and subsequently cooled down to 25° C. The resulting solution was stored under nitrogen atmosphere. A solution with a Ti concentration of 1.82 wt % was obtained.

B1) Preparation of Inventive Catalyst 1, Inv. Cat. 1

All equipment and glassware was dried and kept under inert conditions during synthesis. 305 ml hexane was introduced into a 1.0 I glass reactor equipped with baffles, a reflux condenser and a stirrer.

### Solution I (Comprising the Hydrocarbon Solution)

157 mL of precursor A was added to a Schlenk flask using a graduated pipet.

### Solution II (Comprising the Organo Aluminium Halide)

In a separate Schlenk flask, 75 ml of a 50 wt % solution of ethyl aluminium dichloride (EADC) in hexane was added to 82 ml hexane.

Peristaltic pumps were installed to connect both Schlenk flasks to the 1.0 L glass reactor. The contents of the Schlenk flasks (Solution I and Solution II) were then drop wise simultaneously transferred to the reactor using the following peristaltic pump and reactor settings. Solution I and II were introduced into the glass reactor gradually over a period of 18 min using a peristaltic pump. The addition of Solution I and II being done simultaneously was a key aspect in the procedure.
Reactor Temperature=25° C.
Reactor Stirrer Speed=1400 RPM
Peristaltic Pump Speed=18 RPM (calibrated to transfer 157 mL of solution II in 18 min)
Peristaltic Pump Speed=18 RPM (calibrated to transfer 157 mL of Solution I in 18 min) After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.
   B2) Preparation of Inventive Catalyst 2, Inv. Cat 2

All equipment and glassware was dried and kept under inert conditions during synthesis. 371 ml hexane was introduced into a 1.0 I glass reactor equipped with baffles, a reflux condenser and a stirrer.

### Solution I (the Hydrocarbon Solution)

124 mL of precursor A was added to a Schlenk flask using a graduated pipet.

### Solution II (Comprising the Organo Aluminium Halide)

In a separate Schlenk flask, 59 ml of a 50 wt % solution of ethyl aluminium dichloride (EADC) in hexane was added to 65 ml hexane.

Peristaltic pumps were installed to connect both Schlenk flasks. The contents of the Schlenk flasks were then drop wise simultaneously transferred to the reactor using the following peristaltic pump and reactor settings. Solution I and II were introduced simultaneously into the glass reactor gradually over a period of 19 min using a peristaltic pump. The addition of Solution I and II being done simultaneously was a key aspect in the procedure.
Reactor Temperature=25° C.
Reactor Stirrer Speed=1400 RPM
Peristaltic Pump Speed=16 RPM (calibrated to transfer 124 mL of solution II in 19 min) Peristaltic Pump Speed=16 RPM (calibrated ot transfer 124 mL of solution I in 19 min)

After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.

B3) Preparation of Inventive Catalyst 3, Inv. Cat 3

All equipment and glassware was dried and kept under inert conditions during synthesis. 380 ml hexane was introduced into a 1.0 I glass reactor equipped with baffles, a reflux condenser and a stirrer.

Solution I (the hydrocarbon solution)

124 mL of precursor A was added to a Schlenk flask using a graduated pipet.

### Solution II (Comprising the Organo Aluminium Halide)

In a separate Schlenk flask, 42 ml of a 50 wt % solution of ethyl aluminium dichloride (EADC) in hexane was added to 23 ml hexane.

Peristaltic pumps were installed to connect both Schlenk flasks. The contents of the Schlenk flasks were then drop wise simultaneously transferred to the reactor using the following peristaltic pump and reactor settings.

Solution I and II were simultaneously introduced into the glass reactor gradually over a period of 18 min using a peristaltic pump.
Reactor Temperature=25° C.
Reactor Stirrer Speed=1400 RPM
Peristaltic Pump Speed=31 RPM (calibrated to transfer 124 mL of solution II in 18 min) Peristaltic Pump Speed=14 RPM (calibrated to transfer 65 mL of solution I in 18 min)

After addition of both solutions, the temperature of the reactor was set to 71° C. and the mixture was left to reflux for 2 hours. The contents were transferred to a P4 filter and washed with 2 liter of hexanes. The washed catalyst is transferred to a 500 mL round bottomed flask and stored in nitrogen cabinet.

C1) Preparation of Comparative Catalyst 1, Comp. Cat 1

All equipment and glassware was dried and kept under inert conditions during synthesis. 300 ml hexane was introduced into a 1.0 I glass reactor equipped with baffles, a reflux condenser and a stirrer.

### Solution I (the Hydrocarbon Solution)

157 mL of precursor A was added to the reactor using a graduated pipet.

### Solution II (Comprising the Organo Aluminium Halide)

In a separate Schlenk flask, 59 ml of a 50 wt % solution of ethyl aluminium dichloride (EADC) in hexane was added to 42 ml hexane. Solution II was introduced into the glass reactor containing Solution I, gradually over a period of 15 min using a peristaltic pump.

A peristaltic pump was installed to connect the schlenk flask with solution II to the reactor containing precursor A. The contents of the schlenk flask were then drop wise transferred to the reactor using the following peristaltic pump and reactor settings.

For the purpose of comparative example, the addition of Solution II was done sequentially into the glass reactor that already contained Solution I.
Reactor Temperature=25° C.
Reactor Stirrer Speed=1400 RPM
Peristaltic Pump Speed=18 RPM (calibrated to transfer 117 mL of EADC in 15 min)

After addition of EADC solution, the tubing of the peristaltic pump was rinsed with 50 ml of hexanes. The temperature of the reactor was set to 71° C. and the mixture was left to reflux for 2 hours. The contents were transferred to a P4 filter and washed with 2 liter of hexanes. The washed catalyst is transferred to a 500 mL round bottom flask and stored in nitrogen cabinet.

TABLE 1
reactor conditions, elemental composition,
and particle size of the catalysts.

| | Inv. Cat 1 | Inv. Cat 2 | Inv. Cat 3 | Comp. Cat. 1 |
|---|---|---|---|---|
| Al/Ti (mol/mol) | 6 | 6 | 4 | 6 |
| Precursor A (mol/L) | 0.095 | 0.07 | 0.07 | 0.095 |
| Mg [wt %] | 10.3 | 10.9 | 9.8 | 10.5 |
| Al [wt %] | 3.5 | 3.7 | 3.3 | 4.3 |
| Cl [wt %] | 44.8 | 46.9 | 36.0 | 43.0 |
| Ti [wt %] | 9.4 | 9.5 | 8.4 | 8.5 |
| D₅₀ | 11.5 | 6.2 | 10.1 | 5.74 |
| Span | 1.19 | 1.08 | 1.57 | 1.81 |

The catalyst particle of inventive Inv. Cat. 1-3 have a much lower span than the comparative example Comp. Cat. 1

The catalyst system according to the invention (Inv. Cat 1-3) exhibits a reduced sedimentation time which is at least lower than 40% compared to the comparative example (Comp. Cat. 1).

D) Ethylene homopolymerization

5 liters of dry hexane were added to a reactor having an internal volume of 10 liters and equipped with a stirrer. Next, a hexane solution of 0.8 mol/L triisobutyl aluminum (TiBAl) was added to the reactor. The contents were heated to the desired polymerization temperature while stirring at 750 RPM. Ethylene and hydrogen were added in a certain ratio of partial pressures (pC2 respectively pH2) to reach a desired pressure in the reactor. Next, an aliquot of the catalyst suspension according to one of the above identified catalysts as indicated in the table above (Table 1), containing a previously determined amount of solid catalyst, was added to the reactor the start the polymerization. The total pressure in the reactor was kept constant by dosing ethylene. The hydrogen over ethylene ratio in the headspace of the reactor (H2/C2) was continuously monitored by gas chromatography and was kept constant by dosing hydrogen on demand. After polymerization time of 120 minutes, the pressure in the reactor was reduced to ambient conditions and the reactor was flushed with nitrogen. The reactor temperature was cooled to 35° C. and the slurry was subsequently filtered to collect the wet polymer fluff. The polymer was subsequently rinsed with 10 liters of hexanes, collected and dried in an oven at 40° C. under vacuum for 18 hours. The dried polymer was weighed and analyzed on poured bulk density, density and melt-flow index (MFR190/21.6).

The applied settings for the polymerization experiments can be found in table 2.

TABLE 2
Ethylene homopolymerization reactor settings

| | | Catalyst | TiBAI | Temp. | pC₂ | | Yield | MFR_{190/2.16} | Density |
|---|---|---|---|---|---|---|---|---|---|
| Example | | (mg) | (mM) | (° C.) | (bar) | H₂/C₂ | (g) | (dg/min) | (kg/m³) |
| Ex. 1 | Cat. 1 | 40 | 0.8 | 85 | 1.6 | 3.51 | 437 | 269.6 | 970 |
| Ex. 2 | Cat. 2 | 40 | 0.8 | 85 | 1.6 | 3.48 | 487 | 237 | 973 |
| Ex. 3 | Cat. 3 | 100 | 0.8 | 85 | 1.6 | 2.45 | 230 | n.d. | 969 |
| Ex. 4 | Cat. 1 | 40 | 0.8 | 85 | 1.6 | 3.49 | 403 | 264 | 971 |
| Comp | Comp. | | | | | | | | |

TABLE 3
PE powder morphology

| | | | | | | | | Dry |
|---|---|---|---|---|---|---|---|---|
| | | MFR_{190/2.16} | Density | D₁₀ | D₅₀ | D₉₀ | | flow |
| Example | | (dg/min) | (kg/m³) | (μm) | (μm) | (μm) | Span | (s) |
| Ex. 1 | Cat. 1 | 269.6 | 970 | 162 | 247 | 375 | 0.86 | 19.5 |
| Ex. 2 | Cat. 2 | 237 | 973 | 101 | 150 | 224 | 0.82 | 20.5 |
| Ex. 3 | Cat. 3 | 230 | 969 | 91 | 148 | 236 | 0.98 | n.a. |
| Ex. 4 | Cat. 1 | 264 | 971 | 48 | 113 | 217 | 1.49 | 38.3* |
| Comp | Comp. | | | | | | | |

The PE powder samples made with inventive Inv. Cat. 1-3 have a much lower span than the PE powder samples comparative examples Comp. Cat. 1. The fraction of very fine particles (<105 μm) is lower for Inv. Cat 1-3, as is indicated by D10. Likewise the dry flow is much faster for Cat 1-3. This is means that the PE powders will flow more easily, resulting, for instance improved dosing of polyethylene powder into the extruder.

FIG. 1 shows laser diffraction PSD curves of homopolymerization of PE powder from Ex. 1-4

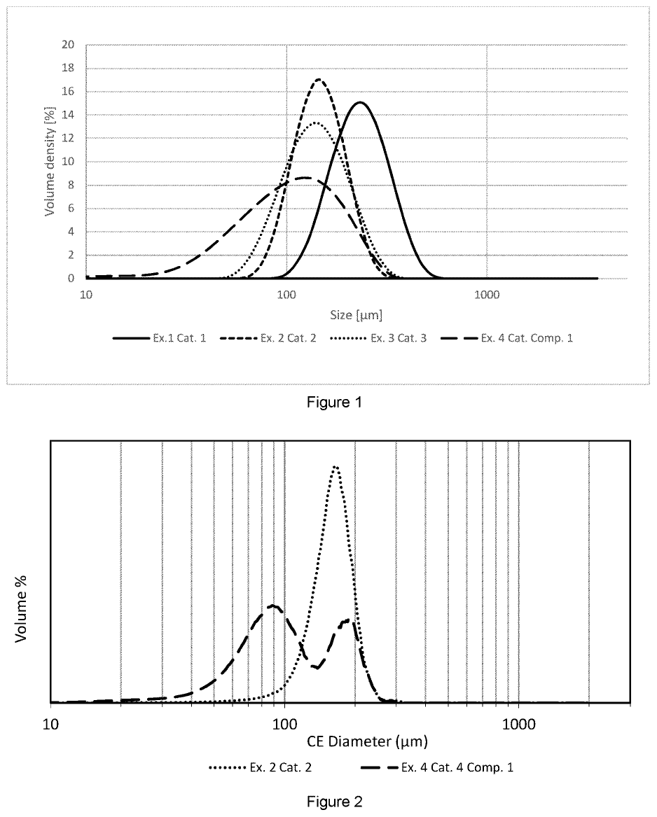

FIG. 2 shows an image analysis of Ex. 2 and Ex. 4 Comparative

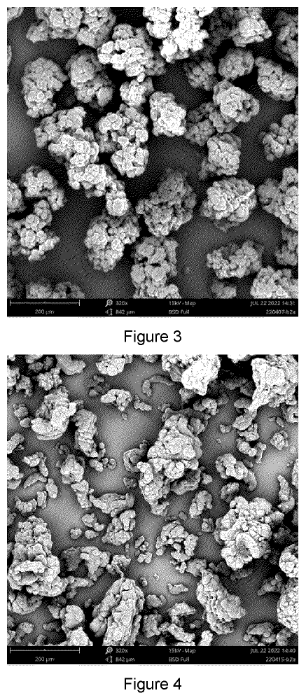

FIG. 3 shows a representative SEM image of PE powder from Ex. 2. As can be seen, the polymer powder shows no particle sizes <100 μm for Ex. 2 Cat. 2

FIG. 4 shows a representative SEM image of PE powder from Ex. 4 Comp. As evidenced by the image, the polymer powder shows significant amount of particles <100 μm Ex. 4 Comp. 1.

### E) Ethylene Copolymerization

The procedure for these experiments were similar to the ethylene homo-polymerization procedure as described above, except for the fact that 1-butene was metered into the reactor directly after hydrogen dosing (before ethylene dosing), before the start of the polymerization. The 1-butene to ethylene molar ratio in the headspace (C4/C2) of the reactor was continuously measured by gas chromatography and 1-butene was fed on demand to keep the ratio at the desired value. The applied settings for the polymerization experiments can be found in Table 4.

TABLE 4
Ethylene copolymerization reactor settings

| | | Cat. | TiBAI | Temp. | pC₂ | | | Yield | MFR_{190/5} | Density |
|---|---|---|---|---|---|---|---|---|---|---|
| Example | Cat. | (mg) | (mM) | (° C.) | (bar) | H₂/C₂ | C₄/C₂ | (g) | (dg/min) | (kg/m³) |
| Ex. 6 | Inv. | 20 | 0.8 | 85 | 1.6 | 0.5 | 0.07 | 383 | 9.6 | 943 |
| | Cat. 1 | | | | | | | | | |
| Ex. 7 | Inv. | 20 | 0.8 | 85 | 1.6 | 0.5 | 0.07 | 412 | 6.9 | n.a. |
| | Cat. 2 | | | | | | | | | |
| Ex. 8 | Comp. | 20 | 0.8 | 85 | 1.6 | 0.5 | 0.07 | 322 | 6.6 | 943 |
| Comp | Cat. 1 | | | | | | | | | |

TABLE 5
PE powder morphology

| | | | | | | | | Dry |
|---|---|---|---|---|---|---|---|---|
| | | MFR_{190/5} | Density | D₁₀ | D₅₀ | D₉₀ | | flow |
| Example | | (dg/min) | (kg/m³) | (μm) | (μm) | (μm) | Span | (s) |
| Ex. 6 | Inv. | 9.6 | 943 | n.d. | n.d. | n.d. | n.d. | 17.0 |
| | Cat. 1 | | | | | | | |
| Ex. 7 | Inv. | 6.9 | n.a. | 115 | 172 | 258 | 0.82 | 35.4 |
| | Cat. 2 | | | | | | | |
| Ex. 8 | Comp. | 6.6 | 943 | n.m. | n.m. | n.m. | n.m. | 110* |
| Comp | Cat. 1 | | | | | | | |

*Powder dry flow of the sample was only achieved by tapping on the dry flow funnel

The PE powder sample made with inventive Inv. Cat. 2 has a much lower span than the PE powder samples made with the comparative examples Comp. Cat. 1. The fraction of very fine particles (<105 μm) is low for Inv. Cat 2, as is indicated by the D₁₀>105 μm. Likewise the dry flow is much faster for Cat 2 compared to Ex. 8 Comp. Where a powder flow could only initiated by tapping on the dry flow funnel.

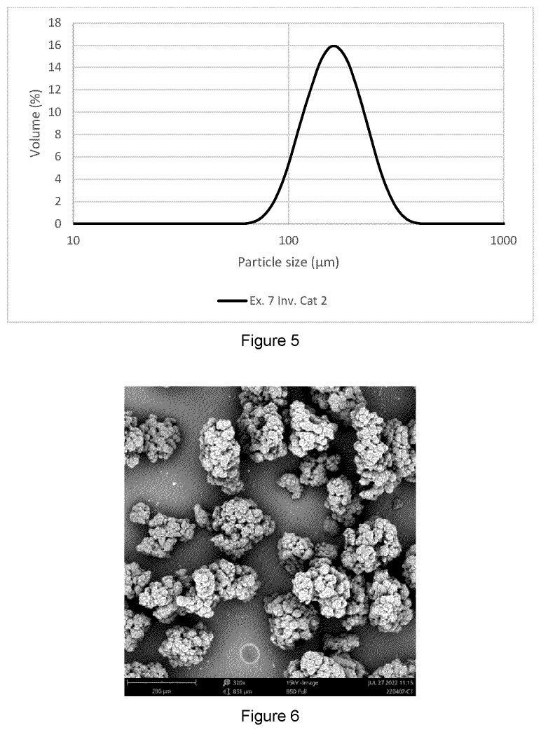

FIG. 5. laser diffraction PSD curve of Ex. 7, Inv. Cat. 2

FIG. 6 shows a SEM image of Ex.7 Cat 2 of the PE copolymer.

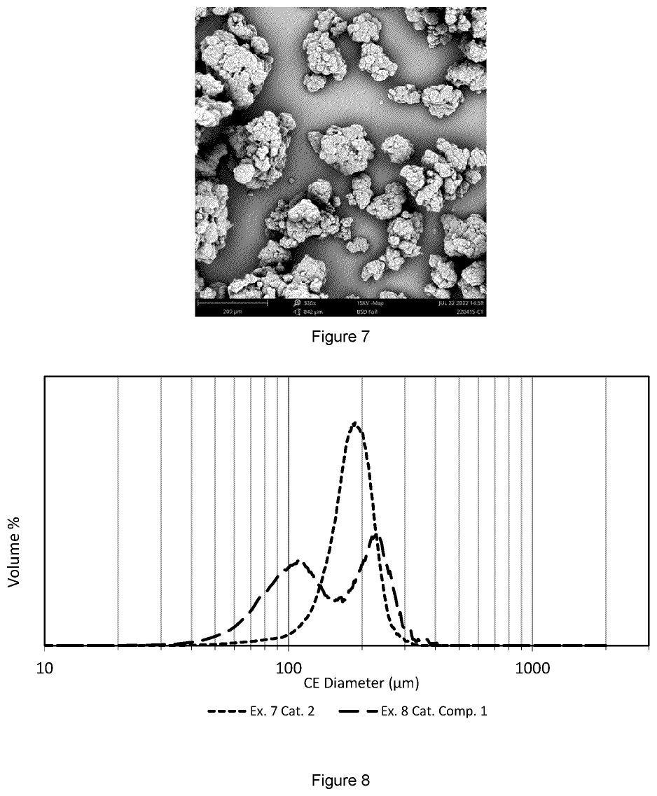

FIG. 7 shows a SEM image of Ex. 8 Cat Comp. 1 of the PE copolymer

FIG. 8 shows light scattering image analysis PSD curves of Ex. 7 and Ex. 8 Comp. of the PE polymer

1. A process for the production of a catalyst system comprising the steps of
1) providing a solution I
wherein solution I comprises a hydrocarbon solution comprising the reaction product of
a) a magnesium-containing compound selected from an organic oxygen-containing magnesium compound and/or a halogen-containing magnesium compound; and
b) an organic oxygen-containing titanium compound
wherein the molar ratio of magnesium: titanium is lower than 3:1;
2) providing a solution II
wherein solution II comprises a hydrocarbon solution comprising
an organo aluminium halide having the formula AlRₙX₃₋ₙ in which R is a
hydrocarbon moiety containing 1-10 carbon atoms, X is a halogen and 0<n<3;
3) selecting a value Y the range from 1-12, wherein Y is defined as the molar ratio of aluminium of solution II to titanium of solution I,
4) dosing solution I and II to a receiving means, in a time t from ≥t₁ to <t_{end} in such a way that Y might vary in the range of Y−35% to Y+5% of Y at any point in time t for the selected Y, and in such a way that solution I or II or solution I and II are selected to be dosed at any point in time t from ≥t₁ to <t_{end},
wherein at t_{end} the selected range of Y is obtained and t_{end} is defined as a point in time
where no further solution selected from solution I or II or I and II is dosed.

2. The process according to claim 1 comprising the step of dosing solution I to the receiving means, in a time from ≥tₛₜₐᵣₜ to <t₁ wherein tₛₜₐᵣₜ is a point in time before t₁ and wherein the time between from ≥tₛₜₐᵣₜ to <t₁ is in the range of 0.05 to 0.125 of the total dosing time ≥tₛₜₐᵣₜ to ≥t_{end}.

3. The process according to claim 1, wherein the total dosing time ≥tₛₜₐᵣₜ to ≤t_{end} is in the range of 5 to 120 minutes.

4. The process according to claim 1, wherein Y is in the range of 4 to 12.

5. The process according to claim 1, comprising the step of dosing solution I and II to a receiving means in a time t from ≥t₁ to <t_{end} in such a way that Y might vary in the range of Y−30% to Y+5% of Y at any point in time t for the selected Y.

6. The process according to claim 1, wherein Y is kept constant at the selected value Y at any point in time t in the time t of ≥t₁ to <t_{end}.

7. The process according to claim 1, comprising the step of dosing a hydrocarbon solution to the receiving means prior to dosing any solution selected form solution I or II or I and II.

8. The process according to claim 1, wherein the molar ratio of magnesium: titanium is in the range of 1.5:1 to 2.2:1.

9. The process according to claim 1, wherein the magnesium compound is a magnesium alkoxide.

10. The process according to claim 1, wherein the organic oxygen containing titanium compound is a titanium alkoxide.

11. The process according to claim 1, wherein the organo aluminium halide has the formula AlRₙX₃₋ₙ in which X is chloride.

12. The process according to claim 11, wherein the organo aluminium halide is ethyl aluminium dichloride (EADC).

13. A polymerisation process for the production of polyethylene comprising the steps of producing a catalyst system according to claim 1 and polymerizing ethylene by contacting said catalyst system with ethylene.

14. A catalyst system obtained by the process according to claim 1, wherein the average particle size distribution (PSD) of the catalyst particles is in the range of 0.8 to 1.6 and wherein PSD is defined as PSD=D₉₀-D₁₀)/D₅₀ and D₁₀, D₉₀ and D₅₀ are measured by laser diffraction.

15. A method for producing polyethylene, the method comprising contacting the catalyst system according to claim 14 with ethylene.
